(19) United States
(12) Patent Application Publication
(10) Pub. No.: US 2002/0178902 A1
(43) Pub. Date: Dec. 5, 2002

(54) Control device for hydraulic and/or mechanical components

(75) Inventors: Alfred Trzmiel, Grafenberg (DE); Roland Meyer, Roth (DE); Andreas Wild, Unterensingen (DE)

Correspondence Address: GUDRUN E. HUCKETT, LONSSTR. 53, WUPPERTAL, 42289, DE

(73) Assignee: Hydraulik-Ring GmbH, Nurtingen (DE)

(21) Appl. No.: 10/057,292

(22) Filed: Jan. 25, 2002

(30) Foreign Application Priority Data
Jan. 26, 2001 (DE) 101 03 426.1

(51) Int. Cl. F16D 28/00; F16H 59/00; F15B 13/044

(52) U.S. Cl. 91/459; 74/473.12; 192/84.1

(57) ABSTRACT

A control device for hydraulic, mechanical, and hydraulic-mechanical components has a housing in which at least one drive element is arranged. The drive element is a piezo element having a voltage-dependent stroke-force behavior. The piezo element acts directly onto the component to be actuated. The control device with the piezo element replaces actuating devices such as solenoids, complete valves, as well as coupling and switching mechanisms.

### BACKGROUND OF THE INVENTION

1. Field of the Invention

The invention relates to a control device for hydraulic and/or mechanical components, comprising a housing in which at least one drive element is arranged.

2. Description of the Related Art

It is known to actuate hydraulic valves with lifting solenoids as control devices. Clutches are opened by means of pressure springs and hydraulic or pneumatic cylinders. Clutches can also be closed by pressure so that the inactive clutch is in the open position and is closed by a hydraulic or pneumatic cylinder. Further components are, for example, gearshift controls whose control devices include gearshift forks, gearshift plates, synchronizing rings and the like. In the case of automated manual transmissions hydraulic actuators are used in order to select the gutters of the transmission and the respective gears/speeds.

These control devices are comparatively complex. For example, the solenoids are comprised of many separate parts and have relatively large dimensions. As a result of the great mass of the lifting device in the solenoid in the form of plungers or armatures, a time delay from the time of supplying the switching current to the response of the hydraulic valve is unavoidable. A great hysteresis and a temperature dependency of the characteristic line of the spring occurs in the case of clutches with a pressure spring. Moreover, large adjusting strokes and a high wear are additional disadvantages. Accordingly, the opening mechanism, for example, a self adjustment for wear compensation of the clutch pads can be controlled only with difficulty. Because of the hysteresis and the temperature dependency, the compensation of fluctuations in the actuating force is also controllable only with difficulty.

In gearshift devices the synchronizing rings must be configured with specially designed friction pads and geometries for adjustment of the rpm and for a low-noise and wear-reduced shifting of the transmission. A lifting stroke or an axial movement of the synchronizing device across a longer travel stroke (magnitude of approximately 10 mm) is required in order to perform the shifting action. The actuating device used for this purpose however exhibits many individual tolerances and is correspondingly inaccurate. Moreover, as a result of wear of the components the course of shifting changes. The synchronizing devices with their complex toothings are also prone to erroneous shifting actions which can cause damage and may lead to a premature failure of the transmission. The shifting time, i.e., the time span for performing the shifting action, which should be as short as possible for various reasons, for example, because of the tractive power interruption, the response time of a device and the like, can not be lowered below a certain duration because of the great travel strokes or lifts with their tolerances and the thus resulting time periods for carrying out these movements.

### SUMMARY OF THE INVENTION

It is therefore an object of the present invention to configure the control device of the aforementioned kind such that very short shifting times can be achieved with a simple constructive configuration.

In accordance with the present invention, this is achieved in that the drive element is at least one piezo element which exhibits a voltage-dependent stroke-force behavior.

With the control device according to the invention, the conventional actuating devices such as solenoids, complete valves, as well as coupling and switching mechanisms are replaced by the piezo element directly acting onto the corresponding device, wherein the piezo element has a voltage-dependent travel-force behavior. By means of the piezo element extremely short response times can be achieved so that a very fast response of the devices to be controlled is possible. The piezo elements are characterized by a compact configuration so that a space-saving and cost-saving use is possible in very different applications. In comparison to solenoids, the piezo elements require only a very minimal amount of energy because the piezo element takes up energy only up to the point of reaching its capacity while a solenoid requires a constant supply of current. The piezo element can act directly onto a valve, a clutch, a selector shaft or a gear so that a very simple configuration with small and compact size results. The obtainable force of the piezo element is with in the kilo newton range. Very large forces can be achieved by a corresponding parallel arrangement of several piezo elements.

In order to be able to adjust the piezo stroke to the different requirements, for example, a certain valve stroke, the piezo elements can also be arranged sequentially behind one another so that the strokes of the individual piezo elements are additive. As a result of the configuration according to the invention, a significant simplification of the actuating mechanism is realized. By a direct actuation of the respective devices, very minimal tolerances result. Hydraulic actuators can be directly controlled by means of the piezo elements without conventional valves. The control function of piezo elements can also be coupled with a measuring function. The currently acting pressure can be simply determined by means of the force that is acting on the piezo element and generated by the hydraulic pressure.

### BRIEF DESCRIPTION OF THE DRAWING

In the drawing:

FIG. 1 is an axial section of a first valve directly controlled by means of a control device according to the invention;

FIG. 2 is an axial section of a second valve directly controlled by a control device according to the invention;

FIG. 3 shows in section a first pilot-operated valve with a control device according to the invention;

FIG. 4 shows in section a second pilot-operated valve with a control device according to the invention;

FIG. 5 shows in axial section a further embodiment of a directly controlled valve with a control device according to the invention;

FIG. 6 shows a further embodiment of a first pilot-operated valve with a control device according to the invention;

FIG. 7 shows in axial section another embodiment of a directly controlled valve with a control device according to the invention;

FIG. 8 shows in axial section another embodiment of a pilot-operated valve with a control device according to the invention;

FIG. 9 shows an axial section of an actuator of a gearshift control with a control device according to the invention;

FIG. 10 shows the actuator according to FIG. 9 with deflected lever;

FIG. 11 shows on an enlarged scale a sectional view of another embodiment of the control device according to FIGS. 9 and 10 in a state without current being supplied;

FIG. 12 shows the control device according to FIG. 11 with current being supplied;

FIG. 13 shows in a representation corresponding to FIG. 11 another embodiment of a control device according to the invention;

FIG. 14 shows the embodiment of the control device of FIG. 13 in a representation corresponding to FIG. 12;

FIG. 15 shows an axial section of a gearshift control with a control device according to the invention;

FIG. 16 shows an axial section of a clutch with a control device according to the invention;

FIG. 17 shows in an illustration corresponding to FIG. 16 another embodiment of a clutch with a control device according to the invention;

FIG. 18 shows partially in axial section and partially in an end view a further embodiment of the control device according to the invention;

FIG. 19 shows an axial section of a further embodiment of the control device according to the invention;

FIG. 20 shows in a side view a further embodiment of the control device according to the invention; and

FIG. 21 shows a section along the line XXI-XXI of FIG. 20.

### DESCRIPTION OF THE PREFERRED EMBODIMENTS

The control devices described in the following can replace conventional actuating devices such as solenoids, complete valves, and the like. These control devices have at least one piezo element which exhibits a voltage-dependent stroke-force behavior. By means of this piezo element very short response times are possible so that the control devices respond very quickly. The piezo elements require only a very small space so that the control devices have a compact configuration, and a space-saving and cost-saving use is possible in very different applications. The piezo elements have also a very minimal energy consumption.

FIG. 1 shows a directly controlled 3/2-port directional control valve with a housing 1 in which a piston 2 is slidably arranged. It has two piston members 3, 4 positioned at an axial spacing from one another which contact the inner wall of the housing 1. The ends 5, 6 of the piston rod 7 project axially past the piston members 3, 4. The left end of the housing 1 in FIG. 1 is closed by a cover 8 which has at least one opening 9 as a tank connector T. The cover 8 delimits together with the oppositely positioned piston member 3 a pressure chamber 10 in which at least one pressure spring 11 is arranged. In the illustrated embodiment, the pressure spring 11 is a coil spring. It is supported with one end on the cover 8 and with the other end on the piston member 3. By means of the pressure spring 11, the piston rod end 6 is held in contact with the piezo element 12 which is axially secured by a radially inwardly oriented flange 13 of the housing 1. Connecting lines 14 for the piezo element 12 are guided through the flange 13 to the exterior. The piezo element 12 contacts with its mantle 15 on the inner wall of the housing 1.

In the initial position illustrated in FIG. 1 the pressure connector P of the directional control valve is separated by the piston member 3 from the work connector A which is connected with the tank connector T. In order to actuate the consumer connected to the work connector, the piezo element 12 is excited so that the piston 2 is moved against the force of the pressure spring 11 to such an extent that the pressure connector P communicates with the work connector A. The medium which is supplied via the pressure connector P and which is under pressure can then flow to the work connector A and from there to the consumer. The work connector A in this position of the piston 2 is separated by the piston member 3 from the tank connector T. As soon as the piezo element 12 is no longer supplied with current, the pressure spring 11 pushes the piston 2 back into the initial position illustrated in FIG. 1 so that the work connector A is again separated from the pressure connector P. Since the tank connector T and the work connector A are now connected with the pressure chamber 10, the pressure medium can now return to the tank T.

In this directional control valve, the piezo element 12 replaces a control device in the form of a solenoid, with which conventionally the piston 2 is moved against the force of the pressure spring 11.

FIG. 2 shows a directly controlled 4/3-port directional control valve whose piston 2 is centered by two pressure springs 11 in a center position. In contrast to the preceding embodiment, a second piezo element 12 is provided which rests against the cover 8 of the housing as well as on the inner wall of the housing 1. The two pressure springs 11 rests against the piezo element 12 as well as against the piston member 3, 4 of the piston 2, respectively. In the spring-centered central position according to FIG. 2, the work connectors A, B of the valve are closed by the piston members 3, 4. The tank connectors T open into the two receiving chambers 10 while the pressure connector P opens into the pressure chamber 16 between the two piston members 3, 4.

In order to connect the work connectors A or B with the pressure connector P, the corresponding piezo element 12 is excited, respectively, so that it elongates and moves the piston 2 against the force of the corresponding oppositely positioned pressure spring 11. When the piston 2 is moved to the left from the center position according to FIG. 2, the pressure connector P is connected with the work connector B while the work connector A is connected with the tank connector T. Accordingly, the consumer connected to the work connector B can be supplied with the required pressurized medium. As soon as the piezo element 12 positioned to the right in FIG. 2 is no longer supplied with current, it shortens so that the piston 2 can be returned by the force of the left pressure spring 11 into the center position. When the work connector A is to be connected with the pressure connector P, the left piezo element 12 is supplied with current so that the piston 2, as a result of the length increase of the piezo element 12, is moved to the right against the force of the pressure spring 11 until the work connector A is connected with the pressure connector P.

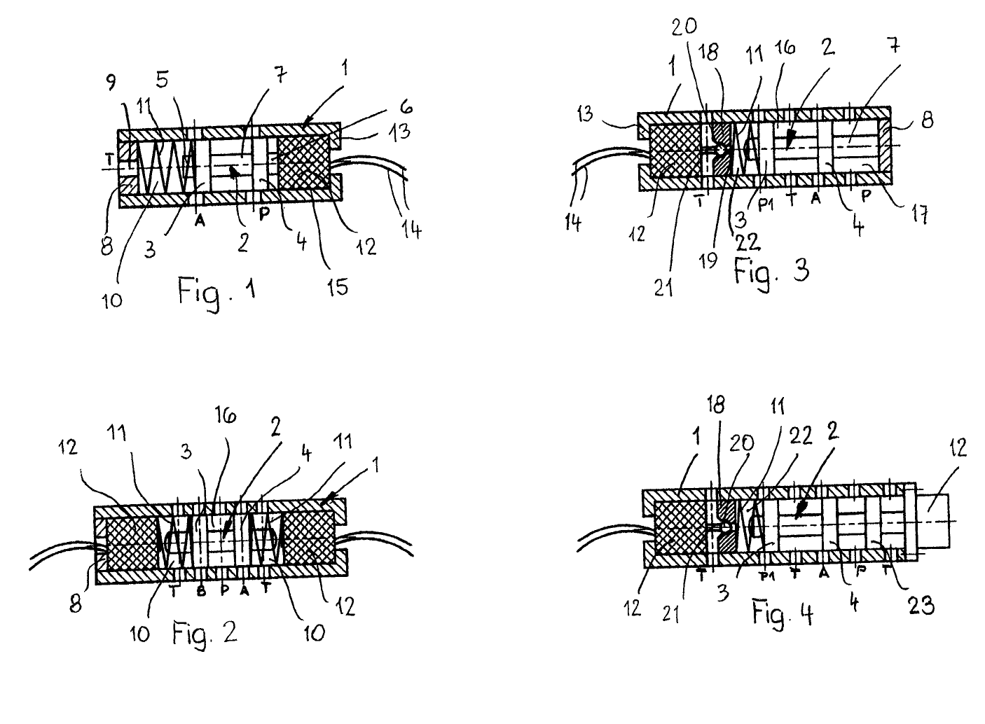

FIG. 3 shows a pilot-operated 3/2-port directional control valve with housing 1 in which the piston 2 is movable against the force of at least one pressure spring 11. The piston 2 supports the two piston members 3, 4 which rests against the inner side of the housing 1. The piston rod 7 is supported with its right end in FIG. 3 on the cover 8 of the housing. The piston member 3 delimits together with the cover 8 a pressure chamber 17 into which the pressure connector P opens.

One end of the pressure spring 11 is supported on the piston member 3 and the other end is supported on a valve seat 18 which is fastened in the housing 1. The piezo element 12 is positioned at a spacing opposite the valve seat 18. It is secured axially by a housing flange 13 and rests against the inner wall of the housing 1. The connecting lines 14 of the piezo element 12 are guided through the flange 13 to the exterior.

The valve seat 18 has a central through opening 19 which is closed by a closing element 20, preferably a ball. The through opening 19 widens conically approximately at half the thickness of the valve seat 18 in the direction toward the piezo element 12. The closing element 20 is secured by a plunger 21 in the closing position illustrated in FIG. 3. The closing element 20 is fastened on the plunger 21. The plunger 21 is actuated by the piezo element 12. The tank connector T is provided in the area between the piezo element 12 and the valve seat 18.

In order to move the piston 2 to the left from the initial position illustrated in FIG. 3, the medium which is under pressure is supplied via the pressure connector P into the pressure chamber 17. As soon as the pressure of the medium acting on the piston member 4 is greater than the force of the pressure spring 11, the piston 2 is moved to such an extent that the work connector A is connected with the pressure connector P. Now the medium which is under pressure flows via the work connector A to the connected consumer. Upon movement of the piston 2, the medium within the pressure chamber 16 between the two piston members 3, 4 is returned via the tank connector T to the tank. The medium between the valve seat 18 and the piston member 3 is pressurized by the piston member 3 upon movement of the piston 2. As long as this pressure is smaller than the counter force acting by the piezo element 12 via the plunger 21 onto the closing element 20, the closing element 20 will close the through opening 19. In order to release or open the through opening 19, the piezo element 12 is supplied with current. It shortens so that the closing element 20 connected via the plunger 21 lifts off the valve seat 18 and the medium can flow via the through opening 19 to the tank connector T between the piezo element 12 and the ball seat 18. In this way, the pressure of the medium in the pressure chamber 22 between the ball seat 18 and the piston member 3 is relieved. When the piezo element 12 is no longer supplied with current, the plunger 21 is returned together with the closing element 20 into the closing position. This directional control valve can be employed in low-pressure applications.

FIG. 4 shows a pilot-operated 3/2-port directional control valve which is also suitable for a high-pressure application. The piston 2, in contrast to the embodiment according to FIG. 3, has three piston members 3, 4, 23 positioned at an axial spacing to one another which contact the inner wall of the valve housing 1. The piezo element 12 with its plunger 21 secures the closing element 20 in the closing position illustrated in FIG. 4 on the valve seat 18. The tank connector T is positioned between the piezo element 12 and the valve seat 18.

The pressure spring 11 in the pressure chamber 22 is supported with its ends on the valve seat 18 and on the piston member 3. Instead of the pressure-loaded cover in the embodiment according to FIG. 3, the directional control valve according to FIG. 4 comprises a solenoid or a further piezo element 12. The piston 2 can be actuated by means of the solenoid or the piezo element 12. The valve according to FIG. 4 operates basically identically to the valve of FIG. 3.

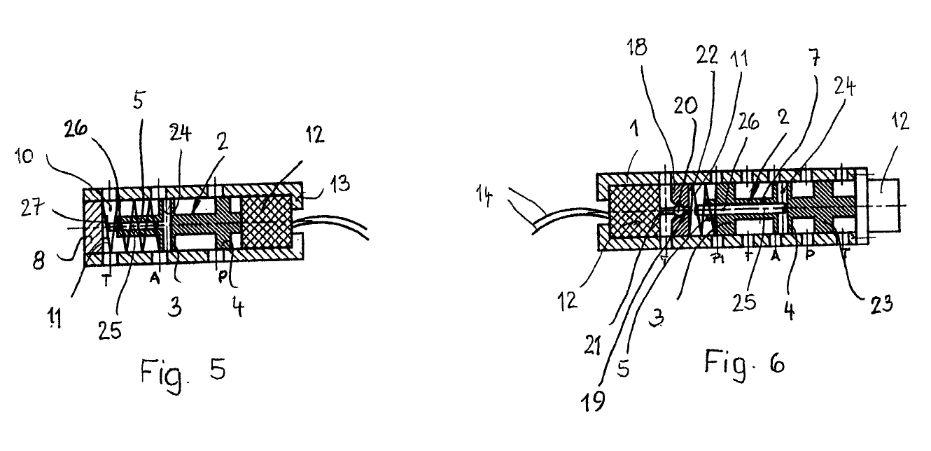

FIG. 5 shows a directly controlled 3/2-port pressure reducing valve which is configured similar to the directional control valve according to FIG. 1. The piston 2 with the two piston members 3, 4 is actuated by the piezo element 12 which is secured by the housing flange 13. The piston member 3 has a bore 24 diametrically penetrating it and opening into a bore 25 which extends centrally and axially through the piston end 5. In comparison to the embodiment of FIG. 1, the piston end 5 is longer and is surrounded by the pressure spring 11 which is supported with one end on the housing cover 8 and with the other end on the piston member 3. A plunger 26 projects into the bore 25 and is supported on the housing cover 8 or a central projection 27 of the housing cover 8. By means of the pressurized medium present within the diametric bore 24 and in the axial bore 25, the plunger 26 is held in contact on the projection 27.

When the piezo element 12 is supplied with current, it elongates so that the piston 2 is moved against the force of the pressure spring 11. Accordingly, the pressure connector P is connected with the work connector A to which the consumer is connected. The pressure medium in the receiving space 12 between the housing cover 8 and the piston member 3 is returned to the tank via the tank connector T upon movement of the piston 2. The piston end 5 moves on the plunger 26 until it contacts the wall of the diametric bore 24 at maximum travel stroke.

When the piezo element 12 is no longer supplied with current, the piston 2 is returned by the pressure spring 11 again into the initial position illustrated in FIG. 5 in which the piston member 3 separates the work connector A from the pressure connector P.

FIG. 6 shows a pilot-operated 3/2-port pressure reducing valve. It comprises the piston 2 with the three piston members 3, 4, 23 in a configuration similar to the embodiment according to FIG. 4. The piezo element 12 is provided in the left end of the housing 1 (see FIG. 6) and has connecting lines 14 extending to the exterior. The piezo element 12 comprises a central axial plunger 21 with the closing element 20 which in the closing position closes the through opening 19 in the valve seat 18. The tank connector T is positioned between the piezo element 12 and the valve seat 18.

The piston 2 is kept by the force of the pressure spring 11 in contact against the solenoid or an additional piezo element 12. The central piston member 4 has a diametric bore 24 into which the axial bore 25 opens, similar to the preceding embodiment. The bore 25 is provided in the piston rod 7 and extends from the central piston member 4 to the left piston end 5. In this axial bore 25 the plunger 26 is arranged which contacts with its right end the inner wall of the diametric bore 24 and whose left end project past the piston end 5 and has a minimal spacing from the valve seat 18. In the initial position illustrated in FIG. 6 in which the piston 2 rests against the right solenoid or against the right piezo element 12, the work connector A is separated by the piston member 3 from the pressure connector P1 and by the piston member 4 from the pressure connector P. The piezo element 12 supplied with current forces as a result of its elongation via the plunger 21 the closing element 20 into the closing position so that the through opening 19 in the valve seat 18 is closed. When the piston 2 is moved by actuation of the right piezo element 12 or a solenoid against the force of the pressure spring 11, the work connector A is connected to the pressure connector P. Moreover, the pressure medium in the pressure chamber 22 between the valve seat 18 and the piston member 3 is pressurized. In order to open the through opening 19, the piezo element 12 is supplied with current so that the plunger 21 and the closing element 20 are retracted and the medium can flow from the pressure chamber 22 through the through opening 19 to the tank connector T.

When the solenoid or the right piezo element 12 is switched off, the plunger 21 of the still excited left piezo element 12 pushes the closing element 20 farther into the closing position. The pressure spring 11, in turn, moves the piston 2 into the initial position according to FIG. 6.

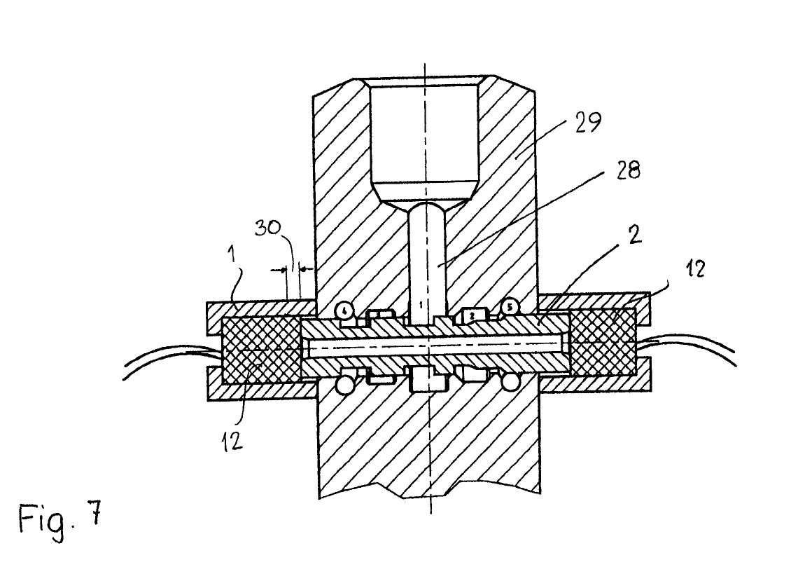

FIG. 7 shows an exemplary application for the function of a directly controlled 5/2-port directional control valve. The passage of a medium through a bore 28 of a component 29 is controlled by the piston 2. The piston 2 projects with its ends laterally past the component 29 and the ends rest with them on a piezo element 12, respectively. Both piezo elements 12 are arranged and secured in the housing 1 in the way described above. The left piezo element 12 in FIG. 7 is supplied with current while the right piezo element 12 is not supplied with current. The maximum stroke of the left piezo element 12 is identified with reference numeral 30. By a corresponding current supply of the two piezo elements 12, the piston 2 can be moved into the required positions. Since the function of the directional control valve is generally known, it is not described in more detail in this context.

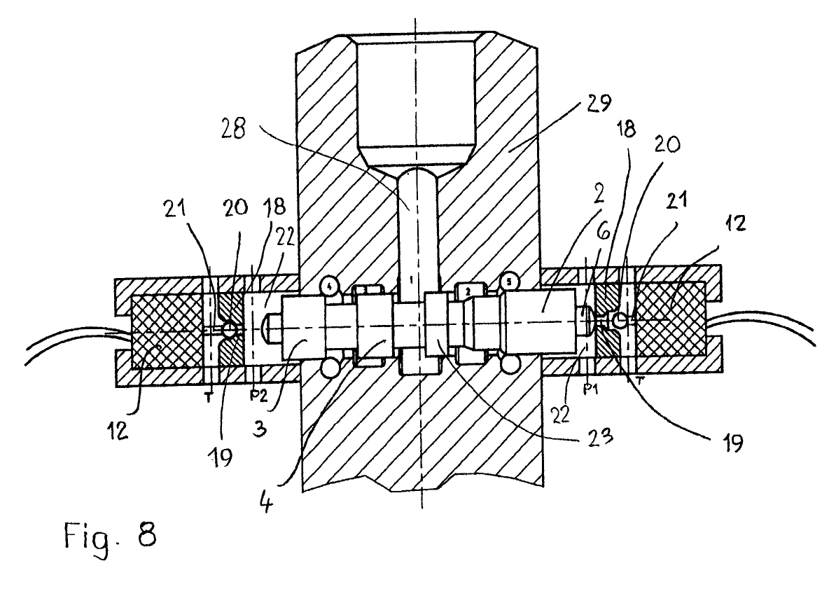

FIG. 8 shows an application for the function of a pilot-operated 5/2-port directional control valve. In this case, the piston 2 has three piston members 3, 4, 23. The two piezo elements 12 on either side of the component 29 each have a plunger 21; each plunger 21 supports a closing element 20, respectively, with which the through opening 19 in the valve seat 18 can be closed. In the pressure chamber 22 between the valve seat 18 and the piston member 3, the pressure connector P2 opens while the pressure connector P1 opens into the pressure chamber 22 between the right valve seat and the neighboring end of the piston 2.

In the illustration according to FIG. 8 the left piezo element 12 is supplied with current so that it elongates and thus performs the corresponding piezo stroke so that the closing element 20 is moved into its closing position in which the through opening 19 of the left valve seat 18 is closed. The right piezo element 12 is not supplied with current so that its plunger 21 with the closing element 20 releases the through opening 19 of the right valve seat 18. Via the pressure connector P2 the corresponding pressure medium is supplied so that the piston 2 is moved to the right to such an extent that the piston end 6 rests against the right valve seat 18. By means of the piston 2 the throughput of the medium through the bore 28 of the component 21 is controlled as known in the art, depending on the position of the piston.

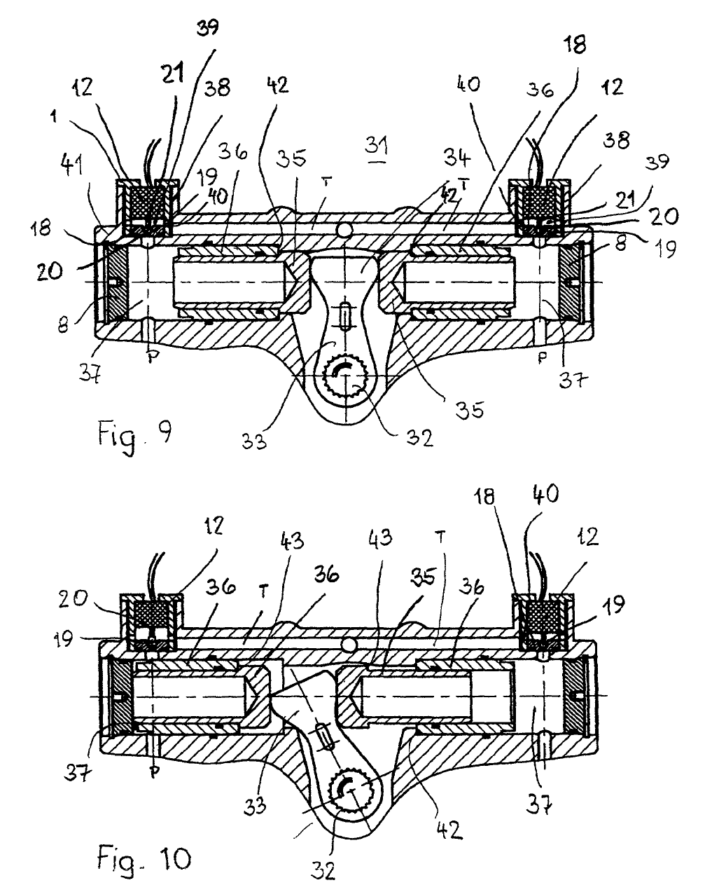

FIGS. 9 and 10 show the position control of an actuator 31 with which a selector shaft 32 of a gearshift control is rotated about its axis. The transmission is an automated manual transmission of a motor vehicle where the selector shaft 32 is rotated about its axis as well as moved in the axial direction in order to be able to select the gutter and the speed/gears of the transmission. A one-arm lever 33 is fixedly secured on the selector shaft 32 and has a free end with a widened portion 34 with opposed ends. Hollow actuator pistons 35 rest with their closed end against the opposed ends of the widened portion 34, respectively. The hollow actuator pistons 35 are movable in bushing-shaped auxiliary pistons 36 which rest slidably against the inner wall of the casing 41. The hollow pistons 35, in turn, rest on the inner wall of the auxiliary pistons 36. The pistons 35, 36 are positioned in a pressure chamber 37 which is closed by the cover 8, respectively. A pressure connector P opens into the two pressure chambers 37, respectively.

The casing 41 has two connecting sockets 38 each receiving a control device. The control device comprises a piezo element 12 which is provided at one end face with the plunger 21 and the closing element 20 with which the through opening 19 in the valve seat 18 can be closed. The piezo element 12 and the valve seat 18 are received in the housing 1 which is inserted into the respective connecting socket 38 and secured therein in a suitable way.

The space 39 between the piezo element 12 and the valve seat 18 is connected by an opening 40, respectively, with the tank connector T which is formed by a bore extending parallel to the axes of the pistons 35, 36 within the casing 41 of the actuator 31.

In the central position according to FIG. 9 the two piezo element 12 are supplied with current so that they perform the piezo stroke thereby closing the through opening 19 of the valve seat 18 by the closing element 20. In this way, the pressure chambers 37 are separated from the openings 40 and thus from the tank connector T. Via the two pressure connectors P the medium which is under pressure is supplied to the pressure chambers 37 so that the two pistons 35, 36 are moved toward one another. The auxiliary pistons 36 are positioned with their end faces facing one another on a casing stop 42, respectively. The casing stops 42 are formed by a radially inwardly oriented annular shoulder on the inner wall of the casing 41, respectively. Since the two hollow pistons 35 are identical, the same forces act on them and the lever 33 is maintained in its central position.

In order to rotate the selector shaft 32, one of the two piezo elements 12 is no longer supplied with current. In the embodiment according to FIG. 10, the left piezo element 12 is not supplied with current. Accordingly, the closing element 20 is released from the through opening 19 so that the medium present within the left pressure chamber 37 flows via the through opening 19 and the opening 40 of the left housing 1 into the tank bore T. Since the right piezo element 12, however, is still supplied with current, its closing element 20 remains in the closing position so that the pressure in the right pressure chamber 37 is maintained. This has the result that the hollow piston 35 is moved farther to the left from the position illustrated in FIG. 9. The right auxiliary piston 36 cannot be moved farther to the left because it is resting against the stop 42 in the direction to the left. Since the left pressure chamber 37 is relieved in the direction toward the tank line T, the lever 33 can be pivoted counterclockwise so that the two left pistons 35, 36 are moved correspondingly. The hollow piston 35 has a stop surface 43 on which the auxiliary piston 36 rests and is thus entrained by the hollow piston 35. The selector shaft 32 is thus rotated about its axis by an amount corresponding to the pivot stroke of the lever 33.

The free ends of the auxiliary piston 36 facing away from one another are configured so as to be reduced with regard to their outer diameter so that in the retracted position of the auxiliary pistons 36 the pressure medium can flow via the pressure line T to the end face of the auxiliary piston 36 facing away from the lever 33 when they can be returned.

When, based on the position according to FIG. 10, the left piezo element 12 is supplied with current and the right piezo element 12 is no longer supplied with current, the closing element 20 of the left piezo element 12 closes the through opening 19. Via the pressure connector P the medium which is under pressure is supplied so that the end face of the left auxiliary piston 36 is loaded with the medium. The auxiliary piston 36 is moved accordingly in FIG. 10 to the right and entrains via the contact surface 43 the hollow piston 35. By means of the lever 33 the hollow piston 35 is first moved back to such an extent until it comes to rest with its contact surface 43 on the auxiliary piston 36. It is then entrained by the hollow piston 35. The medium present within the right pressure chamber 37 flows via the through opening 19 of the right valve seat 18 and the opening 40 into the tank line T. Accordingly, the selector shaft 32 is rotated about its axis corresponding to the pivot stroke of the lever 33.

The tank connector T is released, respectively, by the two piezo elements 12 so that the lever 33 can be pivoted by the desired amount. The loss of pressure medium via the tank line T is very minimal because the through opening 19 of the two valve seats 18 can be closed in the described way. Via the openings 40 in the wall of the housing 1, which have a very small cross-section, only a minimum leakage can take place, if at all. The small openings 40, in fact, provide a hydraulic damping because through the small cross-sectional openings only small amounts of pressure medium can flow. When the control devices are closed with the piezo elements 12, respectively, an immediate pressure build-up takes place in the respective pressure chamber 37 so that the pistons 35, 36 can be moved suddenly into the required position. When both control devices are closed, the pistons 35, 36 are returned into the neutral position illustrated in FIG. 9 in a very short amount of time.

The two tank lines T correlated with the control devices, respectively, are separated from one another.

The casing 41 of the actuator 31 is compact and thus requires only little space. The lever 33 projects into the actuator casing 41 which also contributes to a compact configuration. The contact surfaces of the widened lever portion 34 for the two hollow pistons 35 are advantageously rounded so that the lever 33 can be reliably pivoted. Upon carrying out the pivot movement, the widened lever portion 34 glides along the end faces of the hollow piston 35 which is easily possible because of the rounded configuration of the two end faces of the widened lever portion.

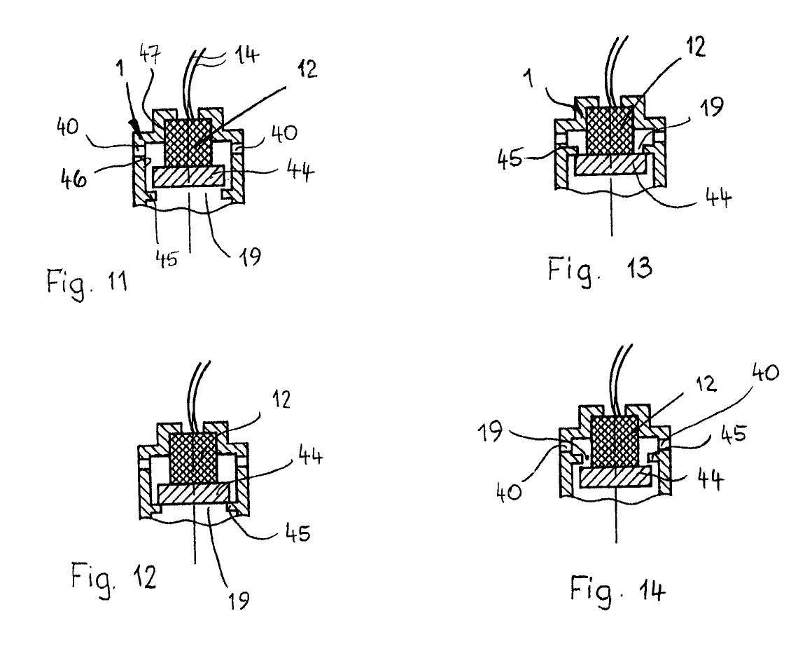

FIGS. 11 through 14 show control devices which, in contrast to the embodiments of FIGS. 3, 4, 6, and 8 through 10, have a large cross-section through opening instead of the small size through opening 19. Accordingly, these control devices are suitable for higher dynamics.

FIGS. 11 and 12 show an embodiment in which the piezo element 12 is provided with a piston 44 at one end face. The piston 44 serves as a closing element for the through opening 19. The through opening 19 is delimited by an annular flange 45 which projects from the inner wall 46 of the housing 1. The housing 1 has at its free end face a depression 47 for receiving the piezo element 12. The connecting lines 14 of the piezo elements 12 extend to the exterior as in the preceding embodiments.

FIG. 11 shows the position of the closing element 44 when the piezo element 12 is not supplied with current. Then the piezo element 12 is shortened so that the connecting element 44 has a spacing relative to the annular flange 45. In this way, the through opening 19 is open so that the pressure medium can flow past the closing element 44 and the piezo element 12 to the openings 40 via which the pressure medium can return to the tank. The closing element 44 has a smaller cross-section than the inner space of the housing 1 but a greater cross-section than the piezo element 12. Since the through opening 19 has a large cross-section, this control device is suitable for higher dynamics as, for example, for the actuator 31 according to FIGS. 9 and 10. The control device according to FIGS. 11 and 12 can be used instead of the two control devices according to FIGS. 9 and 10.

When the piezo element 12 is supplied with current, it is elongated to such an extent that the closing element 44 will come to rest against the annular flange 45 (FIG. 12). The through opening 19 is thus closed.

FIGS. 13 and 14 show a variant of the embodiment according to FIGS. 11 and 12. The difference is only that the through opening 19 is closed when the piezo element 12 is not supplied with current (FIG. 13). In this case, the piston-shaped closing element 44 rests against the bottom side of the annular flange 45 of the housing 1, when the piezo element 12 which extends through the through opening 19 (FIG. 14) is supplied with current, it elongates so that the piston-shaped closing element 44 is lifted off the annular flange 45 and thus releases or opens the through opening 19. The pressure medium can then flow past the closing element 44 to the openings 40 to which the tank line is connected.

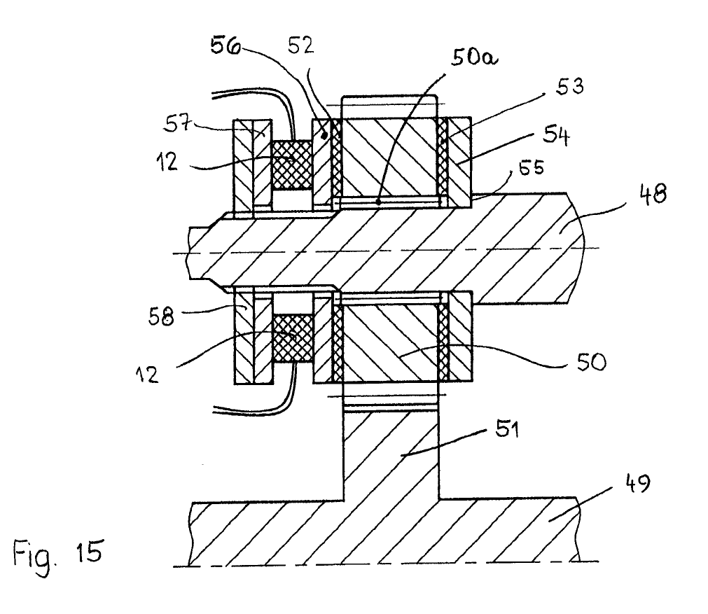

A further embodiment of a gearshift control is illustrated in FIG. 15. Two parallel positioned gear shafts 48 and 49 can be connected in driving connection with one another by the gears 50, 51. The gear 51 is fixedly connected to the transmission shaft 49; in the illustrated embodiment it is a monolithic part thereof. The gear 50 is rotatably supported by means of a bearing 50a on the transmission shaft 48. On both sides of the gear 50 an annular friction pad 52, 53 is provided. The friction pad 53 is positioned with the side opposite the gear 50 on a support ring 54 which is axially supported on a radially outwardly oriented annular shoulder 55 of the transmission shaft 48 and is fixedly connected thereto.

A flat pressure disc 56 is resting on the friction pad 52 and, in contrast to the support ring 54, is not fixedly connected to the transmission shaft 48. On the outer side of the pressure disc 56 facing away from the friction pad 52 several piezo elements 12 are arranged and circumferentially distributed. In correspondence with the preceding embodiments, they have a rectangular cross-section and rest areally with one of their planar outer sides on the also planar outer side of the pressure disc 56. On the opposed outer side of the piezo element 12 a further thin pressure disc 57 is positioned which, as the pressure disc 56, is also not fixedly connected to the transmission shaft 48. The pressure disc 57 is axially secured by a flat support ring 58 which is seated fixedly on the transmission shaft 48.

By means of supplying voltage to the piezo elements 12, which are decoupled from the transmission shaft 48, they elongate (become longer). Since the piezo elements 12 are secured by the support ring 58 in one axial direction, this elongation has the result that the gear 50 is pressed tightly via the friction pads 52, 53 against the support ring 54 which is connected fixed with the transmission shaft 48. Accordingly, by supplying current to the piezo elements 12, the gear 50 is connected frictionally with the transmission shaft 48. This provides a force transmission and torque transmission from the transmission input shaft 49 via the gears 50, 51 onto the transmission shaft 48. A force exerted onto the friction pads 52, 53 is proportional to the voltage supplied to the piezo elements 12. Accordingly, the frictional force can be adjusted continuously as a function of the voltage acting on the piezo elements 12. When the piezo elements 12 are no longer supplied with current, they shorten so that the force acting on the friction pads 52, 53 is reduced such that the gear 50 is rotationally decoupled from the transmission shaft 48.

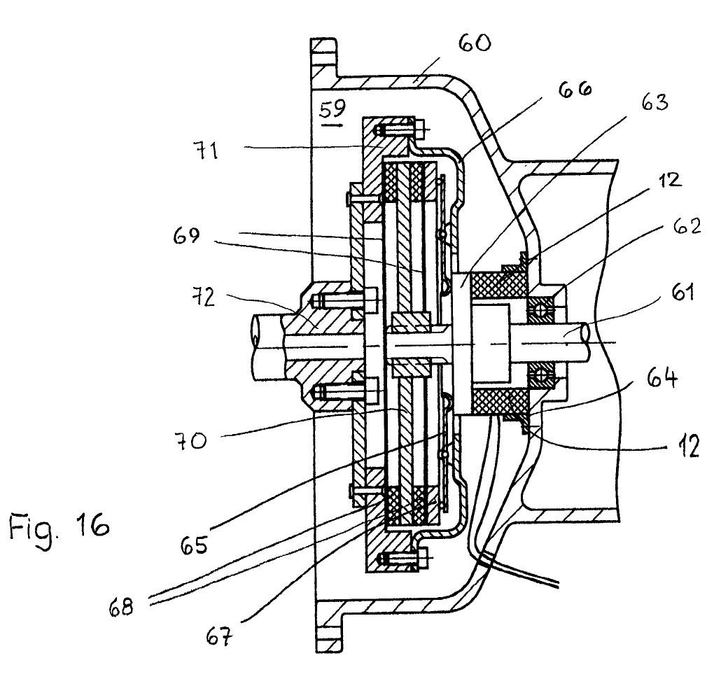

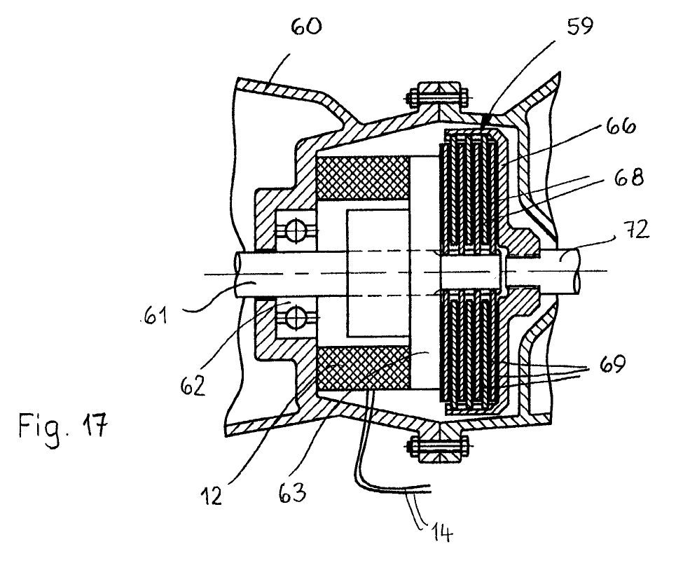

FIG. 16 shows a clutch 59 which is arranged in a transmission casing 60. The transmission casing 60 is penetrated by a transmission shaft 61 which is rotationally supported in the transmission casing 60 by bearings 62. A thrust bearing 63 is seated on the transmission shaft 61. Piezo elements 12 are arranged uniformly about the circumferential area of the thrust bearing 63. They are radially secured by a securing ring 64 which is fastened on the inner side of the transmission casing 60. The piezo elements 12 have a rectangular cross-section and rest with one end face on the bottom side of the thrust bearing 63 and with the other end face on the inner wall of the transmission casing 60.

The thrust bearing 63 is positioned with its end face facing away from the piezo elements 12 on a disk spring 65 which is arranged in a clutch casing 66 of the clutch 59. The disk spring 65 rests, in turn, against a thin pressure ring 67 which, as is known in the art, acts on the clutch pads 68 provided on the edge area of the clutch disks 69. Between the two clutch pads 68 a drive disc 70 is positioned which is fixedly secured on the transmission shaft 61.

The clutch casing 66 spans the clutch disks 69 like a cup and its edge is connected with a flywheel 71 which, in turn, is fixedly connected on the crankshaft 72 which is coaxially positioned relative to the transmission shaft 61.

When the piezo elements 12 are supplied with current, the piezo stroke is transmitted onto the clutch 59 and separates the friction pads 68. The wear of these clutch pads 68 is compensated, as is known in the art, by a self-adjusting mechanism (not illustrated. The clutch 59 opens in the described way with force application. The piezo elements 12 replace the clutch cylinder or the central thruster.

FIG. 16 shows a dry clutch 59; FIG. 17 shows a wet clutch 59 in which the clutch is closed by applying a force. In the transmission casing 60 the clutch casing 66 is arranged in which the clutch disks 69 with the clutch pads 68 are arranged. The clutch casing 66 is seated fixedly on the crankshaft 72 which is positioned coaxially to the transmission shaft 61. It is rotationally supported by bearing 62 in the transmission casing 60 and supports the thrust bearing 63 having the piezo elements 12 arranged on the side facing away from the clutch 59 and distributed about the circumference of the thrust bearing 63. Corresponding to the preceding embodiments piezo elements 12 are supported on the inner side of the transmission casing 60. As in the preceding embodiments the connecting lines 14 of the piezo elements 12 are extended out of the transmission casing 60.

When the piezo elements 12 are supplied with current, the clutch 59 is closed. The torque transmitted via the clutch 59 is proportional to the voltage supplied to the piezo elements 12.

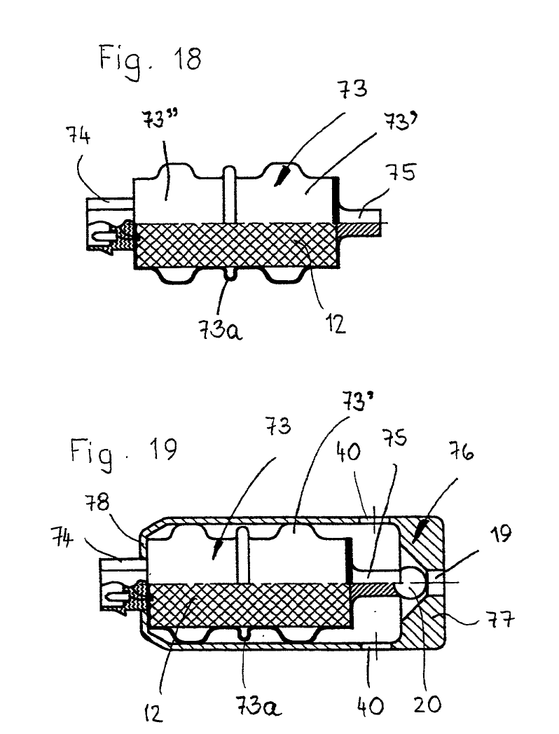

FIG. 18 shows a control device with a housing 73 for the piezo element 12. The housing 73 is comprised of two housing parts 73′ and 73″ which are connected to one another by an elastic expansion element 73a. The expansion element 73a is bellows-shaped and formed as an expandable bellows shaft. The housing 73 secures the piezo element 12 with compressive strain in order to minimize hysteresis effects of the temperature and load changes. The housing 73 functions as a spring, i.e., the force to be applied for a length extension increases proportionally with this length change.

The housing 73 has a plug 74 at one end face and an axial plunger 75 on the opposite end face. By means of the plug 74 the piezo element 12 is connected to a current/voltage supply. The electrical connector can also be realized by the connecting lines 14, as has been explained with the aid of FIGS. 1 through 17. When the piezo element 12 is supplied with current, it elongates. This has the result that the housing part 73′ is moved corresponding to the piezo stroke with elastic deformation of the expansion element 73a relative to the housing part 73″ because the piezo element 12 with its two ends rests against the ends of the housing parts 73′, 73″. By means of the plunger 75 on the end face of the housing parts 73′ a corresponding function such as the closing of the valve seat, movement of the piston, or the like, can be realized. When the piezo element 12 is not supplied with current, it shortens (contracts). The expansion element 73a retracts the housing parts 73′ and maintains it in contact against the piezo element.

The control device according to FIG. 18 can be used in connection with all afore described applications.

In the embodiment according to FIG. 19 the housing 73 is mounted in a housing 76 of a pilot control part. The housing 73 is identical to the embodiment according to FIG. 18. The only difference is that the free end of the plunger 75 is provided with a closing element 20 with which the through opening 19 in the external casing 76 can be closed. The through opening 19 is provided in a thick portion of the bottom 77 of the casing 76.

The plunger 74 for the piezo element 12 projects from the pilot control casing 76. The housing 73 is positioned with its plug side end face on the backside 78 of the pilot control casing 76. Between the housing 73 of the piezo element 12 and the pilot control casing 76 a seal can be arranged in order to prevent pump effects in the space between the plug side end face of the housing 73 and the backside 78 of the pilot control casing 76 caused by the length changes of the piezo element 12. Otherwise, the hydraulic medium between the two spaces would be pumped back and forth in front of and behind the housing 73 which would result in a damping effect and speed losses. The seal (not illustrated), for example, an O-ring, is expediently arranged in the forward part of the housing 73. The bellows element 73a is advantageously also arranged in the area in front of the seal. This has the advantage that the seal upon stroke movement of the piezo element 12 itself is not moved because in this case only the housing parts 73′ is moved axially which is located on the side of the bellows element 73a facing the casing bottom 77.

When the piezo element 12 is supplied with current and accordingly elongated, the closing element 20 closes the through opening 19. When the piezo element 12 is no longer supplied with current, it is shortened so that the through opening 19 is released. The pressure medium can then flow via the through opening 19 to the openings 40 in the pilot control casing 76.

It is also possible to configure the arrangement such that the piezo element 12 in the state when not supplied with current closes by means of the closing element 20 the through opening 19. If it is desired to open the opening 19, the piezo element 12 is supplied with current so that it is contracted and thus releases the through opening 19 by retracting the closing element 20.

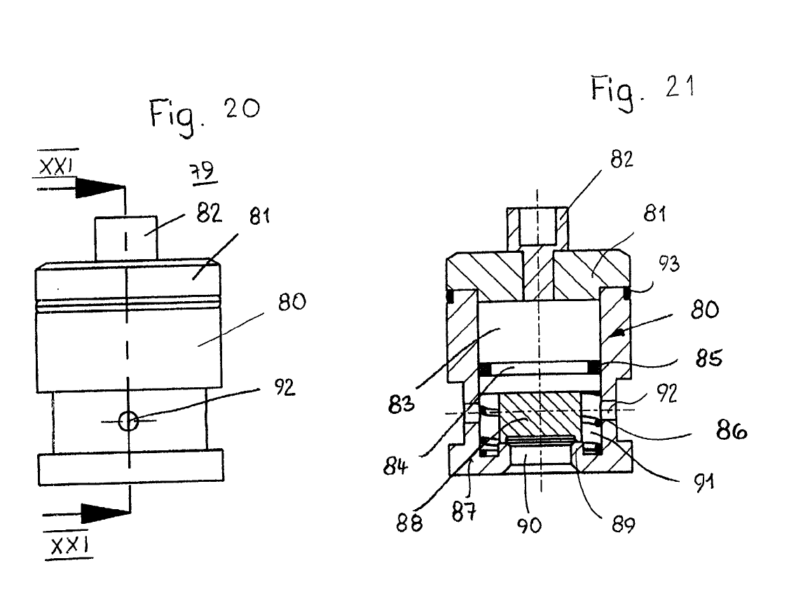

FIGS. 20 and 21 show an electromagnetic actuating device 79 with which pilot control elements can be actuated. The actuating device has a housing 80 which is closed by cover 81 at one end. A plug 82 is inserted into the cover 81 for supplying a flat armature solenoid 83 with current. The solenoid 83 is arranged in the housing 80 and has an annular groove 84 for receiving an annular seal 85 with which the flat armature solenoid 83 is sealed relative to the inner wall of the housing 80.

One end of a pressure spring 86 is supported on the flat armature magnet 83 and the other end is supported on the bottom 87 of the housing 80. The pressure spring 86 surrounds at a spacing the plunger 88 which rests on the end face of a ring 89 projecting radially inwardly from the housing bottom 87. The ring 89 surrounds partially a through opening 19 of the housing bottom 87. The plunger 88 is surrounded by an annular space 91. Openings 92 in the housing mantle open into the space 91. In the position illustrated in FIG. 21, the plunger 88 closes the through opening 90. It is secured in this position by the flat armature solenoid 83 which is correspondingly supplied with current. When it is no longer supplied with current, the pressure spring 86 in FIG. 21 moves it in the upward direction so that the plunger 88 connected with the flat armature solenoid 83 is lifted off the annular projection 89 and, in this way, releases the through opening 90.

The cover 81 is sealed by an annular seal 93 relative to the cylindrical mantle part of the housing 80.

While specific embodiments of the invention have been shown and described in detail to illustrate the inventive principles, it will be understood that the invention may be embodied otherwise without departing from such principles.

What is claimed is:

1. A control device for hydraulic, mechanical, and hydraulic-mechanical components, comprising:
a housing (1, 73);
at least one drive element arranged in the housing;
wherein the at least one drive element is a piezo element (12) having a voltage-dependent stroke-force behavior.

2. The device according to claim 1, further comprising a piston (2) arranged in the housing (1), wherein the piezo element (12) directly controls the piston (2).

3. The device according to claim 2, wherein the piezo element (12) engages one end of the piston (2).

4. The device according to claim 1, further comprising a piston (2) arranged in the housing (1), wherein the piezo element (12) indirectly controls the piston (2).

5. The device according to claim 4, further comprising at least one pressure spring (11) arranged in the housing (1), wherein the piezo element (12) engages the piston (2) with interposition of the at least one pressure spring (11).

6. The device according to claim 4, wherein two of the piezo elements (12) are provided, wherein the two piezo elements (12) act indirectly on opposed ends of the piston (2).

7. The device according to claim 6, wherein the piston (2) is configured to be centered by a spring force in a center position when the two piezo elements (12) are not excited.

8. The device according to claim 1, wherein the piezo element (12) is a part of a directional control valve.

9. The device according to claim 8, wherein the directional control valve is directly controlled or pilot-operated.

10. The device according to claim 9, wherein the directional control valve has a valve seat (18) with a through opening (19) and at least one closing element (20), wherein the piezo element (12) actuates the closing element (20) for closing the through opening (19).

11. The device according to claim 10, wherein the directional control valve has a plunger (21) connected to the piezo element (12) and wherein the closing element (20) is provided on the plunger (21).

12. The device according to claim 10, wherein the through opening (19) is arranged centrally in the valve seat (18).

13. The device according to claim 9, further comprising a piston (2) arranged in the housing (1), wherein two of the piezo elements (12) are provided and engage directly the opposed ends of the piston (2)

14. The device according to claim 13, further comprising pilot control valves each comprising one of the piezo elements (12), wherein the pilot control valves act on the opposed ends of the piston (2), respectively.

15. The device according to claim 14, wherein each piezo element (12) comprises a plunger (21) supporting a closing element (20).

16. The device according to claim 10, wherein the directional control valve has a pressure connector (P, P1, P2) and a tank connector (T), wherein the pressure connector (P, P1, P2) is connected with the tank connector (T) when the through opening (19) is open.

17. The device according to claim 1, wherein the piezo element (12) is configured to control an actuator (31) of an automated manual transmission.

18. The device according to claim 17, wherein the actuator (31) has a lever (33) fixedly connected on a selector shaft (32) and actuator pistons (35) engaging the lever (33) for pivoting the lever (33).

19. The device according to claim 18, wherein the lever (33) has opposed sides and wherein each one of the actuator pistons (35) engages one of the opposed sides, respectively.

20. The device according to claim 19, wherein the actuator pistons are hollow pistons (35).

21. The device according to claim 19, wherein the actuator pistons (35) are loaded by a pressure medium.

22. The device according to claim 19, wherein the actuator (31) has auxiliary pistons (36) and wherein the actuator pistons (35) are moveably arranged in the auxiliary pistons (36).

23. The device according to claim 22, wherein the auxiliary pistons (36) have an end position and rest against a casing stop (42), respectively, when in the end position.

24. The device according to claim 22, wherein the actuator pistons (35) have a stop (43), respectively, and wherein the auxiliary pistons (36) are positioned in a movement path of the stop (43) of the pistons (35).

25. The device according to claim 22, wherein the actuator (31) has a casing and wherein the actuator pistons (35) and auxiliary pistons (36) delimited a pressure chamber (37) for the pressure medium in the casing of the actuator (31).

26. The device according to claim 25, wherein the casing of the actuator (31) has a tank line (T) and the pressure chamber (37) is connected to the tank line (T).

27. The device according to claim 26, wherein the actuator (31) has a closing element (20) configured to close the tank line (T), wherein the closing element is adjustable with the piezo element (12).

28. The device according to claim 1, comprising a closing element (20, 44) configured to close a tank line (T) of the device, wherein the closing element is adjustable with the piezo element (12).

29. The device according to claim 28, comprising a valve seat (18) with a through opening (19) arranged in the housing (1), wherein the closing element (20) is a ball which closes a through opening (19) in the valve seat (18).

30. The device according to claim 28, wherein the housing has a through opening (19) and wherein the closing element (4) is a piston connected to the piezo element (12).

31. The device according to claim 30, wherein the closing element (44) closes the through opening (19) either when the piezo element (12) is supplied with current or not supplied with current.

32. The device according to claim 1, wherein the piezo element (12) is a coupling element of a gearshift control.

33. The device according to claim 32, wherein the gearshift control has a gear (50) and a shaft (48), wherein the gear (50) is configured to be fixedly connected with the shaft (48) when the piezo element (12) is supplied with current.

34. The device according to claim 33, wherein the gearshift control has two pressure disks (56, 57), wherein one of the two pressure disks is secured on a first support ring (58) fixedly connected to the shaft (48), wherein the piezo element (12) is positioned between the two pressure disks (56, 57).

35. The device according to claim 34, wherein the gear (50) is seated rotatably on the shaft (48) and has opposed sides provided with a friction pad (52, 53), respectively.

36. The device according to claim 35, wherein, when supplying the piezo element (12) with current, the gear (50) is connected frictionally with the shaft (48) through the friction pads (52, 53) and the first support ring (58) and a second support ring (54) secured on the shaft (48).

37. The device according to claim 1, wherein the piezo element (12) is part of a clutch (59) comprising clutch disks (69) with friction pads (68), wherein, when the piezo element (12) is supplied with current, the clutch disks (69) either engage one another by friction pads (68) or separate from one another.

38. The device according to claim 37, wherein the piezo element (12) acts onto a thrust bearing (63) of the clutch (59).

39. The device according to claim 37, wherein the clutch (69) is configured to be received in a transmission casing (60) and wherein the piezo element (12) is supported on the transmission casing (60).

40. The device according to claim 37, wherein the clutch (69) has a thrust bearing (63) and wherein several of the piezo elements (12) are provided and distributed about the circumference of the thrust bearing (63).

41. The device according to claim 1, wherein the housing (73) is comprised of a first housing part (73′) and a second housing part, wherein the first housing part (73′) is movable by the piezo element (12).

42. The device according to claim 41, wherein the first housing part (73′) is connected by at least one elastically yielding element (73a) to the second housing part.

43. The device according to claim 42, wherein the elastically yielding element (73a) is a bellows. pg,37

44. The device according to claim 41, wherein the piezo element (12) has a first end resting against the first housing part (73′) and a second end resting against the second housing part.

45. The device according to claim 41, further comprising an external casing (76), wherein the housing (73) is arranged in the external casing (76).

46. The device according to claim 44, wherein the external casing (76) has a valve seat (77) with a through opening (19), wherein the housing (73) has a closing element (20) configured to close the through opening (19) of the valve seat (18).

47. The device according to claim 46, wherein the housing (73) has an end face provided with a plunger (75), wherein the closing element (20) is connected to the plunger (75).
